(19) United States
(12) Patent Application Publication
(10) Pub. No.: US 2010/0231010 A1
(43) Pub. Date: Sep. 16, 2010

(54) Foam Filler For Placement Between Automobile Seats

(76) Inventor: Jack M. Manley, Winter Park, FL (US)

Correspondence Address: LITMAN LAW OFFICES, LTD., POST OFFICE BOX 41200, SOUTH STATION, ARLINGTON, VA, 22204, US

(21) Appl. No.: 12/308,388

(22) PCT Filed: Jun. 26, 2007
(86) PCT No.: PCT/US2007/014696

§ 371 Date: Dec. 12, 2008

Related U.S. Application Data
(60) Provisional application No. 60/816,353, filed on Jun. 26, 2006.

(51) Int. Cl. B60N 2/44

(52) U.S. Cl. 297/182

(57) ABSTRACT

The filler device for placement between seats/consoles is a one-piece, rugged polymer body (10) having an elongate blade and a seat belt boss extending either rearward or laterally from the blade. The blade has an upper portion (12) of substantially uniform width throughout its length, and a wedge-shaped lower portion (13) adapted for insertion between the automobile seat cushion and a console (C). The seat belt boss has a greater width than the blade and defines an opening (20) through which the buckle receiver (B) of a seat belt may be inserted to retain the filler wedged in place. In alternative embodiments, the filler (10) may have a cell phone holder or a cup holder extending laterally from the front end of the blade.

### TECHNICAL FIELD

The present invention relates to motor vehicle accessories, and more particularly to a filler device for placement between the seat and console of an automobile.

### BACKGROUND ART

Coins, papers, pens, and debris are often lodged or lost in a crevice between an automobile seat, such as a driver seat, and a storage console in an automobile. Since the crevice is narrow and cannot be reached by adult-sized hands, it is difficult for the refuse to be removed. As items continue to fall into the crevice the refuse accumulates on the floor of the automobile and can possibly become lodged in seat tracks disposed under the seats, preventing the seat from moving forward or backward. Spilled beverages, food particles, and anything perishable can be particularly problematic because these substances may scatter or dissolve upon impacting the vehicle carpet and may cause the passenger compartment to smell.

The present invention is also designed to prevent injury to automobile owners and the public in general. Many people try to clean the crevice between the seat and the console by jamming their hands into the crevice and pushing debris in one direction or the other. However, because it is generally not possible to see down into the crevice, people injure their hands on the sharp metal or plastic edges of vehicle seat parts or seat tracks during this process. Personal jewelry such as rings, watches, bracelets and other items also frequently catch on seat and seat track components thereby trapping the hands of the cleaner. In addition to the problems associated with cleaning the crevice, many people also create a safety hazard by trying to retrieve dropped items such as cell phones, pens, eyewear, etc. from between seats and consoles while driving.

Therefore, a filler device for placement between seats/consoles is needed that will fit within the crevice as well as accommodate an automobile seat belt head.

Thus, a filler device for placement between seats/consoles solving the aforementioned problems is desired.

### DISCLOSURE OF INVENTION

The disclosure is directed to a filler device for placement between a seat and console. The device comprises a one-piece body. The body has an elongate blade with an upper portion of substantially uniform width throughout its length, and a wedge-shaped lower portion. The body is adapted for insertion in a crevice between an automobile seat cushion and an automobile console. A seat belt boss extends from the blade. The seat belt boss defines an opening adapted for insertion of a seat belt buckle receptacle therethrough. In operation, the blade of the device fills the crevice between the seat and the console, and the seat belt buckle receptacle is inserted through the seat belt boss and thereby retains the device in position in the crevice.

The disclosure is also directed to a system for filling crevices adjacent to a vehicle console. The system includes a driver side unit and a passenger side unit. Each of the units has an elongate blade segment for insertion in a crevice between a vehicle seat and a console. Each unit also has a seat belt boss segment extending from the blade segment. The seat belt boss segment has an opening adapted for insertion of a seat belt buckle receptacle therethrough. The driver side unit is adapted to fit between a driver seat and a console and the passenger side unit device is adapted to fit between the passenger seat and the console. The driver side unit is a mirror image of the passenger side unit.

### BRIEF DESCRIPTION OF THE DRAWINGS

FIG. 1 is an environmental, perspective view of a filler device for placement between seats/consoles according to the present invention as shown from the top rear.

FIG. 2 is a front perspective view of the filler device for placement between seats/consoles according to the present invention.

FIG. 3 is a front perspective view of an alternative embodiment of a filler device for placement between seats/consoles according to the present invention.

FIG. 4 is a front perspective view another alternative embodiment of a filler device for placement between seats/consoles according to the present invention having a cell phone holder.

FIG. 5 is a front perspective view of another alternative embodiment of a filler device for placement between seats/consoles according to the present invention having a cup holder.

FIG. 6 is a bottom perspective view of the passenger and driver versions of a filler device for placement between seats/consoles according to the present invention.

### BEST MODES FOR CARRYING OUT THE INVENTION

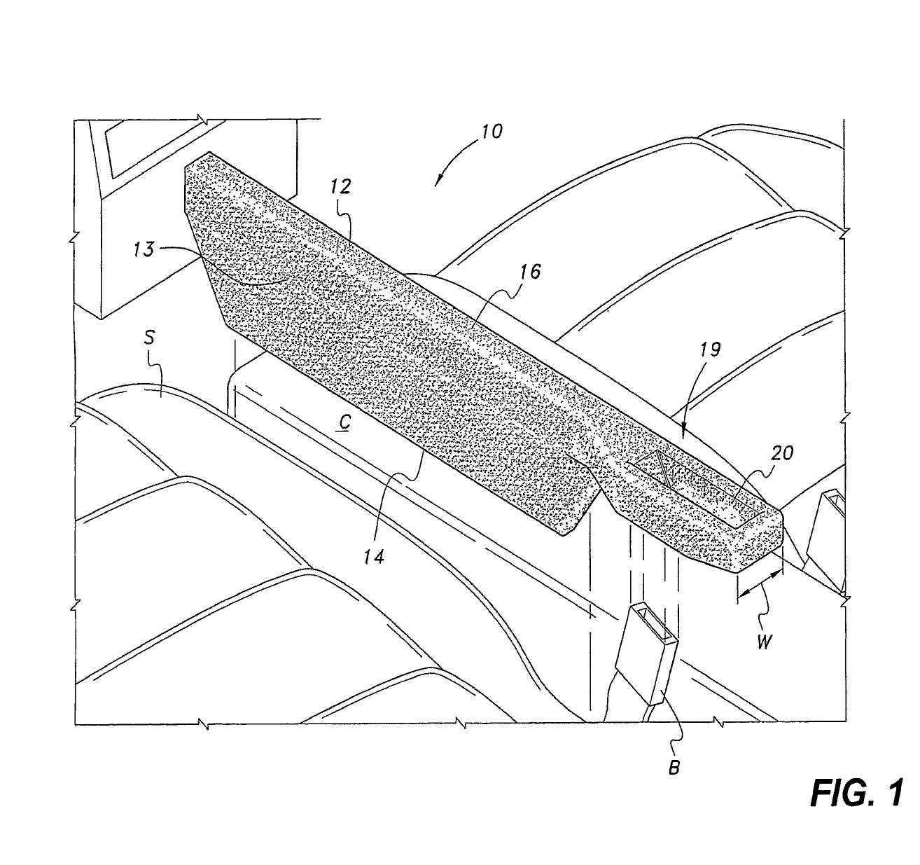

As generally shown in FIG. 1, the filler 10 comprises an elongate blade 16 and a seat belt boss 19 that extends from the blade 16. In the preferred embodiment, the boss 19 extends longitudinally in the same plane as the blade 16. The blade 16 has an upper portion 12 of substantially uniform width throughout its length, and a wedge-shaped lower portion 13 that tapers down to a thin bottom edge 14 so that the device 10 is adapted for insertion between the automobile seat cushion S and the console C. The seat belt boss 19 has a greater width than the blade upper portion 12 and defines an opening 20 through which a seat belt buckle receiver B may be inserted to retain the filler 10 wedged in place. The seat belt boss 19 is preferably positioned adjacent the area in which seat belt receptacle B emanates.

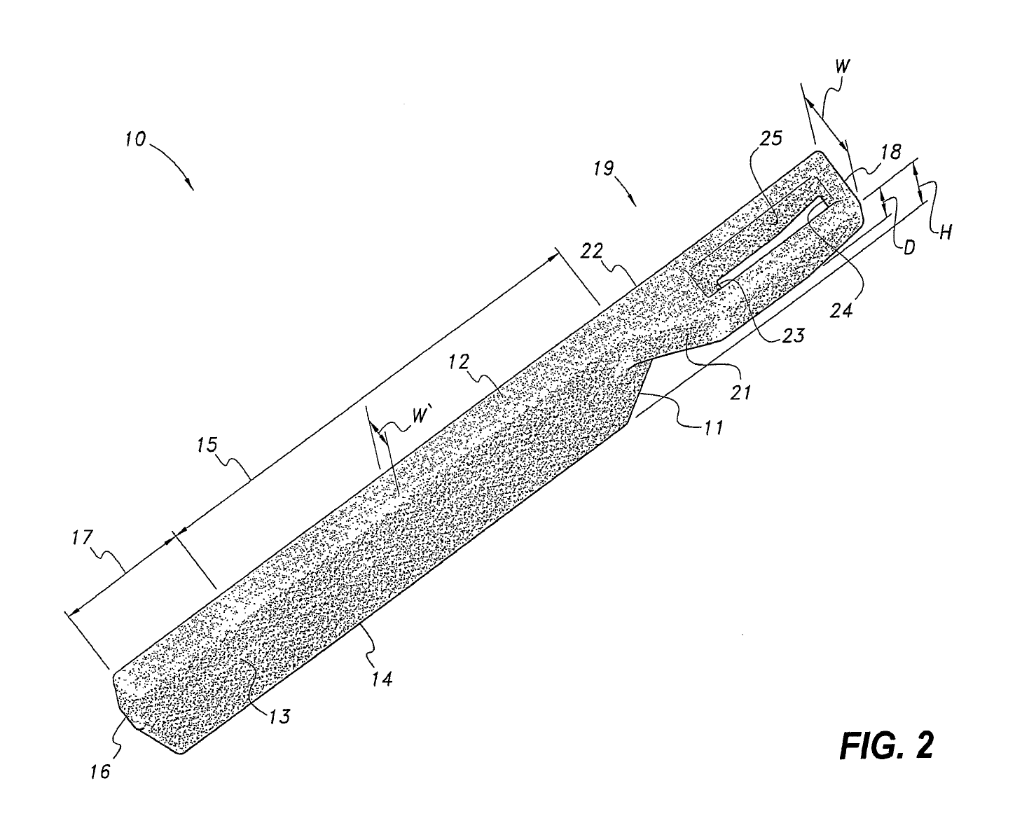

As best shown in FIG. 2, the filler blade upper portion 12 extends longitudinally to form a front section 17, and a rear section 15. In a preferred embodiment, a longitudinal side 21 of the seat belt boss 19 angles away from a longitudinal centerline of the blade 12 until a predetermined width W is achieved. The angled longitudinal side 21 is designed to snugly follow a contour of the seat cushion S, when the device 10 is installed. An exemplary ratio of the seat belt boss predetermined width W to a blade upper portion width W′ may be approximately 2:1.

The remaining longitudinal side 22 is disposed parallel to the longitudinal centerline of the blade upper portion 12 and extends to a rear end 18 of the seat belt boss 19. The remaining longitudinal side 22 is designed to follow a substantially linear contour of the automobile console C when the device 10 is installed.

Again referring to FIGS. 1 and 2, four sidewalls of the seat belt boss 19 define the opening 20. The sidewalls of the opening 20 have a maximum depth D that is sufficiently less than the overall height H of the device 10 to facilitate passage of the seat belt receptacle, i.e., receiver B, through the opening 20. A front lateral sidewall 23 is obtusely slanted so that a typically angled seat belt buckle receiver or receptacle B can slip through the opening 20 in an unimpeded manner. The remaining sidewalls, i.e., longitudinal sidewalls 25 and rear lateral sidewall 24, may be vertical. Bottom edges of the longitudinal sidewalls may angle upward from approximately a midpoint of their length to meet a bottom edge of the rear sidewall. When the seat belt receptacle B is positioned through the opening 20, the opening 20 of the filler 10 keeps the filler 10 in position between the seat cushion S and the console C, even when the automobile seat is shifted forward or backward.

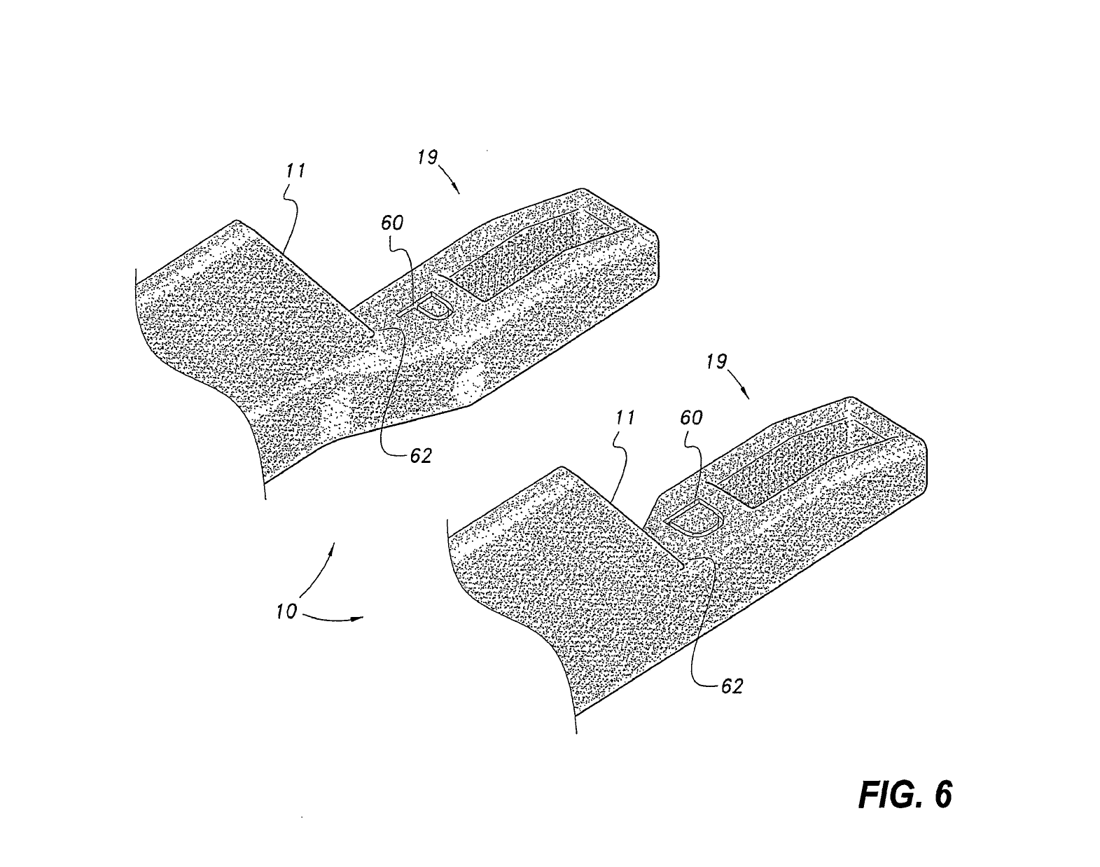

To provide an esthetically pleasing and functional shape, the blade upper portion 12 joins the wedge shaped blade lower portion 13 in a manner that may be beveled or curved. As shown in FIGS. 2 and 6, a rear edge 11 of the blade 16 may be angled rearward as the edge 11 extends from the bottom 14 of the blade lower portion 13 to a boss underside 62. The edge 11 may be angled to conform to a specific or general vehicle passenger compartment configuration.

The filler 10 may have an esthetically pleasing rough surface. The filler 10 may be made to have any length sufficient to fit into any crevice size in an automobile. Likewise, the opening 20 of the filler 10 can be made of any size to fit around the seat belt receptacle B in any vehicle. In use, the filler 10 does not interfere with the normal function of the seat belt because sufficient clearance exists between the mechanism of seat belt receiver, i.e., receptacle B and the opening 20.

The filler 10 is made from a polymer material, and may be rigid, but is preferably made from a polymer foam, such as polyurethane, that has sufficient stiffness to provide firm support for loads that may rest on top of the filler 10, but has sufficient flexibility, compressibility, and resilience that the filler 10 will bend or compress upon the application of moderate force, but will regain its shape when the force is removed.

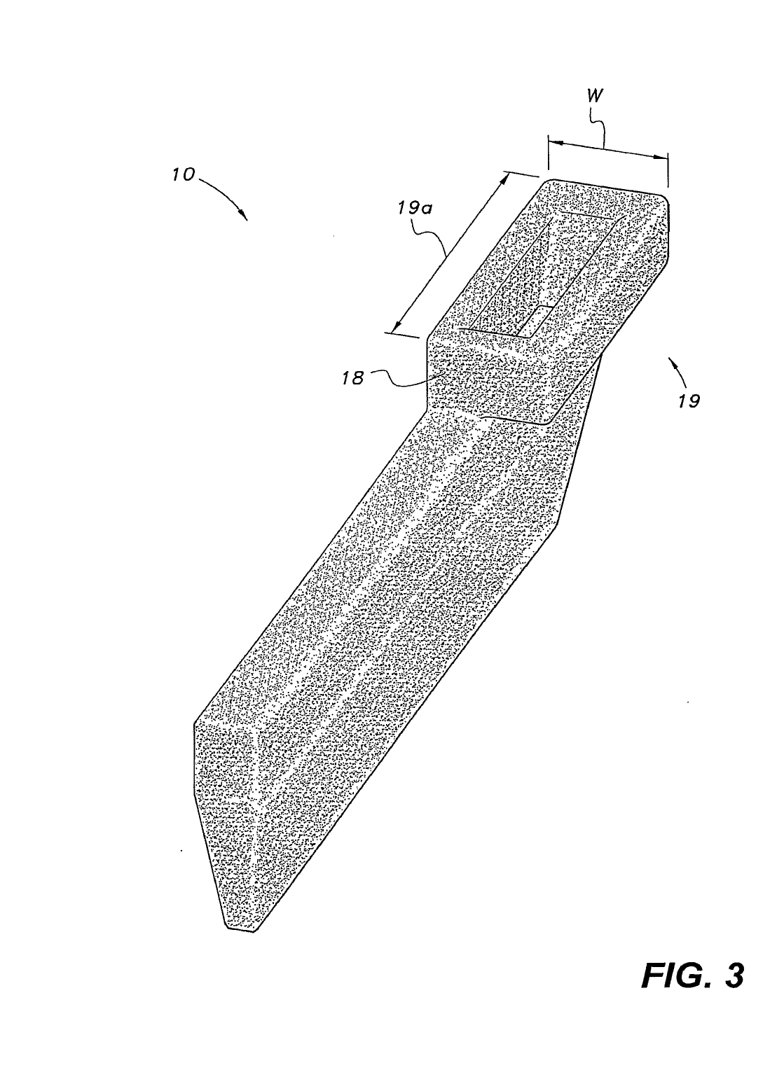

An alternative offset embodiment of the invention is shown in FIG. 3. In the offset embodiment, the seat belt boss 19 of the device 10 may extend vertically above the rear section 15 of the blade upper portion 12 and may have a length 19a so that the seat belt boss rear end 18 does not extend longitudinally beyond the rear section 15 of the blade upper portion 12. This configuration is provided to accommodate older style vehicles in which the vehicle consoles are lower relative to the seats.

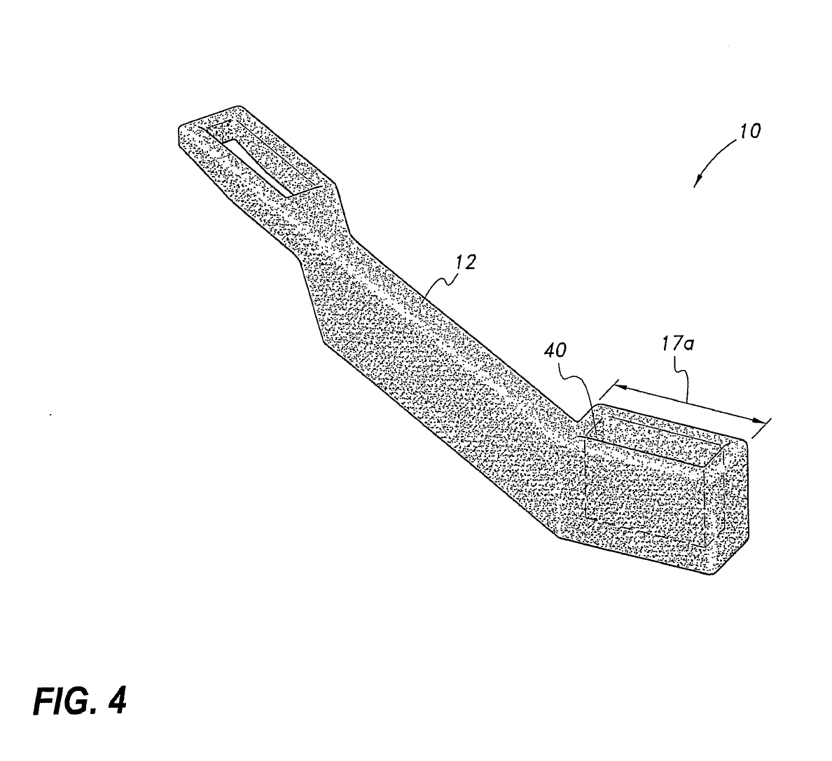

An alternative embodiment incorporating an electronic component holder is shown FIG. 4. As shown in FIG. 4, the electronic component holding embodiment of the filler 10 may comprise a front section 17a that may be angled away from a longitudinal centerline of the blade upper portion 12. The pocket 40 extends vertically downward from the top of the front section 17a, and may be adapted to hold a cell phone, PDA, or similar device.

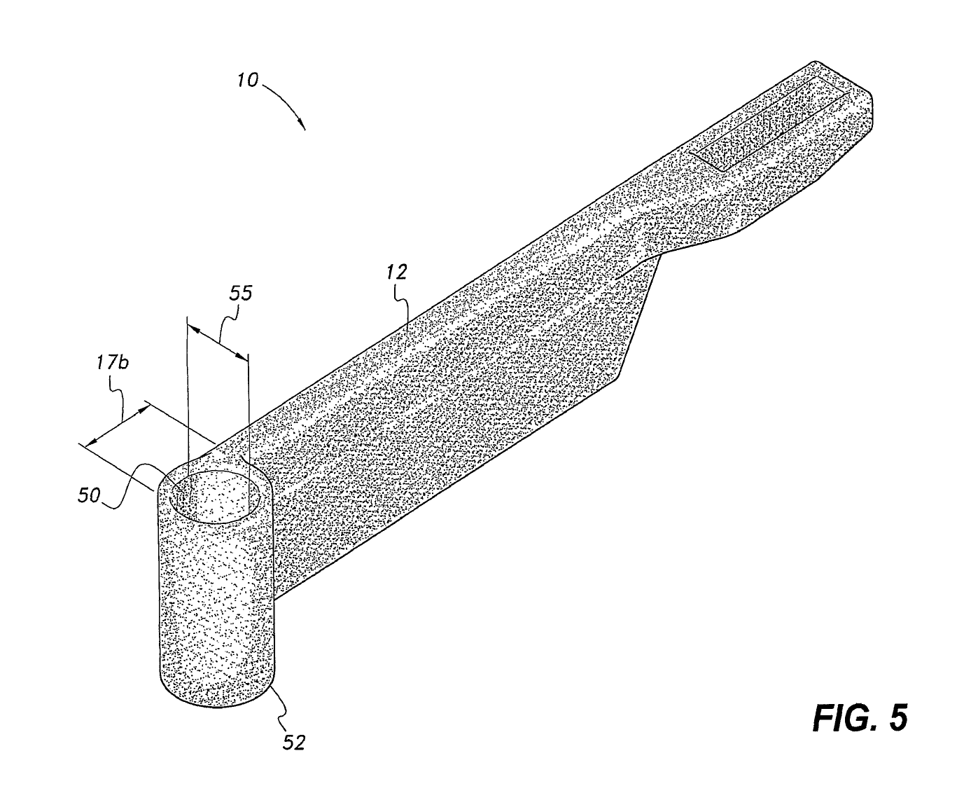

An alternative embodiment incorporating a cup holder is shown in FIG. 5. As shown in FIG. 5, a cup holder embodiment of the filler 10 may comprise a front section 17b that has a cylindrical shaped pocket 50, which is adapted to hold a cup or other similarly shaped beverage container. The pocket 50 extends vertically downward from the top of the front section 17b. A disk-shaped bottom 52 provides support for the cup or similar beverage container. Moreover, a diameter 55 of the cylindrical cup holder pocket 50 extends laterally to the left or right away the longitudinal centerline of the blade upper portion 12, depending on whether the device 10 is for the left side car seat or the right side car seat.

The current invention may also comprise a filler device system as shown in FIG. 6. The system is comprised of a driver side unit designed to occupy the crevice between the driver seat and a console, and a passenger side unit designed to occupy a crevice between the console and a passenger seat. The driver side filler unit and the passenger side unit may form mirror images of each other. As shown in FIG. 6, indicia 60 may be marked or stamped on the boss underside 62 to identify the filler device 10 as being a driver side unit or a passenger side unit.

It is to be understood that the present invention is not limited to the embodiments described above, but encompasses any and all embodiments within the scope of the following claims.

1. A filler device for placement between a seat and console, the device comprising a one-piece body having:
an elongate blade with an upper portion of substantially uniform width throughout its length, and a wedge-shaped lower portion adapted for insertion in a crevice between an automobile seat cushion and an automobile console; and
a seat belt boss extending from the blade, the seat belt boss defining an opening adapted for insertion of a seat belt buckle receptacle therethrough,
wherein the blade fills the crevice between the seat and the console, and the seat belt buckle receptacle inserted through the seat belt boss retains the device in position in the crevice.

2. The filler device of claim 1 wherein the device is comprised of a flexible semi-rigid compressible material.

3. The filler device of claim 2 wherein the device is comprised of polymer foam.

4. The filler device of claim 3 wherein the device is comprised of polyurethane.

5. The filler device of claim 1 wherein the boss opening is a rectangular slot.

6. The filler device of claim 1 wherein the seat belt boss extends longitudinally from the rear of the blade.

7. The filler device of claim 1 wherein the seat belt boss extends laterally from the rear of the blade.

8. The filler device of claim 7 wherein the seat belt boss extends vertically from the blade.

9. The filler device of claim 1 wherein a compartment extends from a front portion of the blade.

10. The filler device of claim 1 wherein an electronic component holder extends from the blade.

11. The filler device of claim 10 wherein the electronic component holder extends longitudinally from a front portion of the blade.

12. The filler device of claim 1 wherein a cylindrical compartment extends from the

13. The filler device of claim 12 wherein the cylindrical compartment extends from a front portion of the blade and is adapted to hold a beverage cup.

14. The filler device of claim 1 wherein the blade has a front vertical edge and a rear vertical edge, the rear vertical edge extends angularly toward the seat belt boss to conform to a vehicle passenger compartment configuration.

15. The filler device of claim 1 wherein a front lateral sidewall of the boss opening is obtusely slanted so that the seat belt buckle receptacle can slip through the boss opening in an unimpeded manner.

16. The filler device of claim 1 wherein the seat belt boss is twice as wide as the blade.

17. A system for filling crevices adjacent a vehicle console, the system comprising:
a driver side unit and a passenger side unit, each of the units having:
an elongate blade segment for insertion in a crevice between a vehicle seat and a console; and
a seat belt boss segment extending from the blade segment, the seat belt boss segment having an opening adapted for insertion of a seat belt buckle receptacle therethrough;
wherein the driver side unit is adapted to fit between a driver seat and a console and the passenger side unit is adapted to fit between the passenger seat and the console, the drivers side unit being a mirror image of the passenger side unit.
